(19) United States
(12) Patent Application Publication
(10) Pub. No.: US 2010/0115458 A1
(43) Pub. Date: May 6, 2010

(54) PANNING A NATIVE DISPLAY ON A MOBILE COMPUTING DEVICE TO A WINDOW, INTERPRETING A GESTURE-BASED INSTRUCTION TO SCROLL CONTENTS OF THE WINDOW, AND WRAPPING TEXT ON THE WINDOW

(76) Inventors: Adam Marano, Pompano Beach, FL (US); Christopher Fleck, Boca Raton, FL (US); Gus Pinto, Boca Raton, FL (US); Mark Templeton, Gulfstream, FL (US)

Correspondence Address: CHOATE, HALL & STEWART / CITRIX SYSTEMS, INC., TWO INTERNATIONAL PLACE, BOSTON, MA, 02110, US

(21) Appl. No.: 12/605,132

(22) Filed: Oct. 23, 2009

Related U.S. Application Data
(60) Provisional application No. 61/108,532, filed on Oct. 26, 2008.

(51) Int. Cl. G06F 3/048; G06F 3/033

(52) U.S. Cl. 715/784; 715/800; 715/781; 715/863

(57) ABSTRACT

A method and system for rendering a window from an extended virtual screen on a native display of a mobile computing device is described. The system includes a server that detects a server, a first window associated with an application executing on the server, the server outputting the application to an extended virtual screen; identifies coordinates associated with a position of the first window on the extended virtual screen; and transmits the coordinates of the first window to a mobile computing device to display the first window on a native display of the mobile computing device. The system also includes a mobile computing device that receives a gesture-based instruction on the native display; evaluates contents of a second window at a location where the gesture-based instruction is received; scrolls the contents of the second window if the contents include a scrollbar; and pans the contents of the second window if the contents exclude a scrollbar.

### CROSS-REFERENCE TO PROVISIONAL APPLICATION

This application claims priority under 35 U.S.C. §119(e) to U.S. Provisional Application No. 61/108,532, filed on Oct. 26, 2008, the entire disclosure of which is incorporated herein by reference.

### FIELD OF THE INVENTION

The present disclosure relates generally to displaying applications on mobile computing devices. In particular, the present disclosure relates to methods and systems for panning a native display on a mobile computing device to a window, interpreting a gesture-based instruction to scroll contents of the window, and wrapping text on the window.

### BACKGROUND OF THE INVENTION

Remote access systems have enabled users to access workspaces, computing environment, applications, and files on servers from various portals. With the increasing prevalence of mobile computing devices, users can also access applications and files on those servers from a handheld device. However, native displays on such devices typically have low resolution. As a result, a user may be able to view only a portion of an application or file on a mobile computing device's screen. The user obtains additional information by scrolling around the application or file on the native display.

The low resolution of the native display poses operating challenges. For example, a window may open outside the purview of the native display. Because the user may not have a reason to scroll around the application or file, the user may miss important notifications or warnings. Additionally, a window, such as a child dialogue box, may require user input before the application continues executing. If the user cannot see the window, the application simply appears frozen.

Further, on a mobile computing device, gesture-based instructions on the native display may produce undesired results because the instructions do not normally contemplate low resolution displays. In one example, touching and dragging a window on the native display may be interpreted solely as an instruction to move the window. In another example, zooming in on text within a window may enlarge the size of the text, but the limited display may cut off words and sentences. Such complicates undermine the user's experience of accessing applications and files with the mobile computing device.

### SUMMARY OF THE INVENTION

The present disclosure is directed to a method and system for rendering a window from an extended virtual screen on a native display of a mobile computing device. In one embodiment, the disclosure relates to panning the native display to a new window that should be brought to the user's attention. Thus, when the server detects a child dialogue box, notification, warning, or other such window, the server instructs the mobile computing device to pan to the appropriate location on the extended virtual screen. Therefore, the mobile computing device user can be kept informed of matters relating to use of the application, as well as provide input to the application.

In another embodiment, the disclosure relates to interpreting a gesture-based instruction on a native display to scroll the contents of a window instead of panning the contents or the window itself. When the mobile computing device receives such an instruction, the device examines the window being acted upon for a scrollbar. If the window includes a scrollbar, the mobile computing device scrolls the contents, even if the user did not manipulate the scrollbar, itself. Therefore, by interpreting a gesture-based instruction via context, a user may achieve different results from applications and files using pre-known gestures.

In yet another embodiment, the disclosure relates to ensuring text is wrapped in a window when a user zooms in on the application. The mobile computing device calculates a new font size and a server calls a function to display the application in that size and adjust wrapping parameters automatically. Therefore, a user can view contiguous contents, rather than scrolling about for additional content in the new font size.

In one aspect of the presently described system and method, a method for displaying, on a mobile computing device, a window of an application executing on a server is shown and described. The method includes detecting, by a server, a window associated with an application executing on the server, the server outputting the application to an extended virtual screen. The method further includes identifying, by the server, coordinates associated with a position of the window on the extended virtual screen and transmitting, by the server, the coordinates of the window to the mobile computing device to display the window on a native display of the mobile computing device. The window is one of a dialogue box, a user interface, a notification, and a warning.

In more embodiments, the method also includes comparing, by the server, a resolution of the extended virtual screen on the server with a resolution of the native display on the mobile computing device; determining, by the server, if the resolutions differ by a predetermined threshold; and transmitting, by the server, an instruction for zooming on the window if the resolutions differ by at least the predetermined threshold. In additional embodiments, the coordinates of the window are obtained by scraping the extended virtual screen. In various embodiments, the server detects the window in response to an event trigger, where the event trigger is selected from a group consisting of an event trigger coded by an application developer and an event trigger inserted by an application user. The user of the mobile computing device specifies the event trigger by, for example, customizing the application executing on the server.

In other embodiments, the method also includes receiving, by the mobile computing device, a gesture-based instruction on the native display; evaluating, by the mobile computing device, contents of a window at a location where the gesture-based instruction is received; scrolling, by the mobile computing device, the contents of the window if the contents include a scrollbar; and panning, by the mobile computing device, the contents of the window if the contents exclude a scrollbar.

In another aspect of the present disclosure, a computer-implemented system for displaying a window of an application executing on a server on a native display of a mobile computing device is shown and described. The system includes a server including a processor that detects a window associated with an application and identifies coordinates associated with a position of the window on an extended virtual screen; and a transceiver that transmits the coordinates of the window to a mobile computing device. In this particular embodiment, the mobile computing device includes a native display that displays the window according to the coordinates identified by the server. The window is one of a dialogue box, a user interface, a notification, and a warning.

In one embodiment of the system, the processor compares a resolution of the extended virtual screen on the server with a resolution of the native display on the mobile computing device, determines if the resolutions differ by a predetermined threshold, and transmits an instruction for zooming on the window if the resolutions differ by at least the predetermined threshold. In another embodiment, the processor scrapes the extended virtual screen to identify the coordinates of the window. In yet another embodiment, the processor detects the window in response to an event trigger, where the event trigger is selected from a group consisting of an event trigger coded by an application developer and an event trigger inserted by an application user. In this particular embodiment, a user of the mobile computing device specifies the event trigger by customizing the application executing on the server. In many of these embodiments, the native display on the mobile computing device receives a gesture-based instruction; and the processor on the mobile computing device evaluates contents of a window at a location where the gesture-based instruction is received, scrolls the contents of the window if the contents include a scrollbar, and pans the contents of the window when the contents exclude a scrollbar.

In yet another aspect, a method of interpreting a gesture-based instruction according to contents of a window displayed on a native display of a mobile computing device is described. The method includes receiving, by a mobile computing device, a gesture-based instruction on a native display of the mobile computing device; evaluating, by the mobile computing device, contents of a window at a location where the gesture-based instruction is received; scrolling, by the mobile computing device, the contents of the window if the contents include a scrollbar; and panning, by the mobile computing device, the contents of the window if the contents exclude a scrollbar.

In one embodiment, scrolling the contents of the window includes transmitting, by the mobile computing device, an instruction to scroll contents of the window output by an application executing on a server. In another embodiment, scrolling the contents of the window includes receiving, by the mobile computing device, updated contents of the window from the server according to the transmitted instruction, and displaying, by the mobile computing device, the updated contents on the native display. In additional embodiments, evaluating contents of a window comprises scraping the window to determine if the window includes a scrollbar.

In many embodiments, the method also includes calculating, by the mobile computing device, a new font size based on the gesture-based instruction; transmitting, by the mobile computing device, the new font size to a server executing the application; applying, by the server, a global function to the operating system of the server to adjust the application to the new font size; and transmitting, by the server, the application in the new font size to the mobile computing device.

In yet another aspect, a mobile computing device for interpreting a gesture-based instruction according to contents of a window displayed on a native display of a mobile computing device is shown and described. The mobile computing device includes a native display that receives a gesture-based instruction. The mobile computing device also includes a processor that evaluates contents of a window at a location where the gesture-based instruction is received; scrolls the contents of the window if the contents include a scrollbar; and pans the contents of the window if the contents exclude a scrollbar.

In some embodiments, the processor scrolls the contents of the window by transmitting an instruction to scroll contents of the window output by an application executing on a server. In further embodiments, the processor scrolls the contents of the window by receiving, from a server, updated contents of the window according to the transmitted instruction. In additional embodiments, the processor evaluates contents of the window by scraping the window to determine if the window includes a scrollbar. In numerous embodiments, the processor calculates a new font size based on the gesture-based instruction and transmits the new font size to a server executing the application, and the server applies a global function to the operating system of the server to adjust the application to the new font size and transmits the application in the new font size to the mobile computing device.

In yet another aspect, a method for rendering a window from an extended virtual screen on a native display of a mobile computing device is shown and described. The method includes detecting, by a server, a first window associated with an application executing on the server, the server outputting the application to an extended virtual screen. The method also includes identifying, by the server, coordinates associated with a position of the first window on the extended virtual screen. The method further includes transmitting, by the server, the coordinates of the first window to a mobile computing device to display the first window on a native display of the mobile computing device. The method also includes receiving, by the mobile computing device, a gesture-based instruction on the native display. The method also includes evaluating, by the mobile computing device, contents of a second window at a location where the gesture-based instruction is received. The method also includes scrolling, by the mobile computing device, the contents of the second window if the contents include a scrollbar, and panning, by the mobile computing device, the contents of the second window if the contents exclude a scrollbar.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a block diagram depicting one embodiment of a system for displaying, on a mobile computing device, a window of an application executing on a server;

FIG. 2 is a flow diagram illustrating a method for displaying, on a mobile computing device, a window of an application executing on a server in accordance with one embodiment of the present disclosure;

FIG. 3 is a block diagram illustrating a conventional display, on a mobile computing device, of an application executing on a server;

FIGS. 4 and 5 are block diagrams illustrating a system for panning a user interface of the application of FIG. 3 into a native screen of a mobile computing device, in accordance with the present disclosure;

FIG. 6 is a flow diagram depicting one embodiment of a method for interpreting a gesture-based instruction according to contents of a window displayed on a native display of a mobile computing device; and

FIG. 7 is a flow diagram depicting one embodiment of another method for interpreting a gesture-based instruction according to contents of a window displayed on a native display of a mobile computing device.

### DETAILED DESCRIPTION

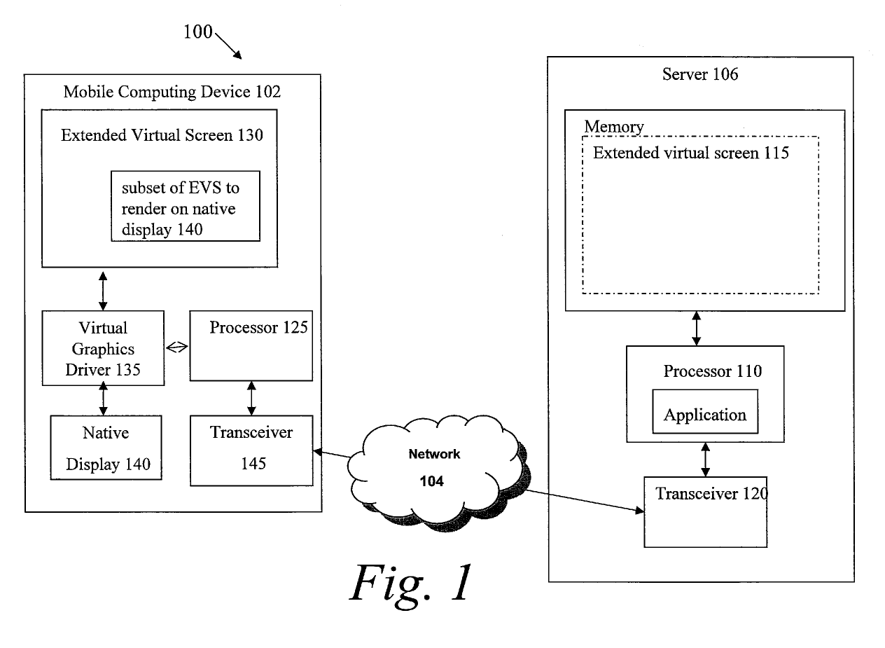

Referring to FIG. 1, a block diagram illustrates one embodiment of a system 100 for displaying, on a mobile computing device, an application executing on a server 106. In brief overview, the system includes a server 106 that communicates with a mobile computing device 102 over a network 104. The server 106 executes an application via a processor 110 and outputs the application to an extended virtual screen 115. The server 106 transmits output on the extended virtual screen 115 over the network 104 to the mobile computing device 102, via a transceiver 120. A processor 125 on the mobile computing device 102 stores the received output on another extended virtual screen 130. The virtual graphics driver 135 and the processor 125 communicate to display a portion of the extended virtual screen 130 on the native display 140.

In operation, the processor 110 on the server 106 detects a window associated with the application and identifies coordinates associated with the window's position on the extended virtual screen 115. The mobile computing device 102 receives the coordinates and pans the native display 140 to the corresponding position on the extended virtual screen 130. Thus, the user of the mobile computing device 102 need not take action to view windows that initially appear out of view.

Further, in accordance with the present disclosure, the processor 125 of the mobile computing device 102 interprets a gesture-based instruction received through the native display 140 to be, for example, an instruction to pan. In such example, the server 106 or mobile computing device 102 determines if the window located where the gesture-based instruction was received has a scrollbar. If so, instead of panning the contents of the window or moving the window itself, the server 106 or mobile computing device 102 scrolls the window's contents. Such intelligent interpretation of the gesture provides simplified user commands for interacting with an application on a low resolution native display.

In another embodiment, the processor 125 interprets a gesture-based instruction as a zoom instruction and calculates the corresponding new font size. The mobile computing device 102 transmits the new font size to the server 106, which adjusts the application accordingly, accounting for the text currently on display at the native display 140 and the need for wrapping application text on the limited display. The server 106 transmits the application in the desired format to the mobile computing device 102 for display. Accordingly, the user may change the font size for the application without scrolling about the application for contiguous data.

With continuing reference to FIG. 1, the server 106 and its components for use in the system 100 will now be described. Server 106 can be an application server, application gateway, gateway server, virtualization server, or deployment server. In some embodiments, the server 106 functions as an application server or a master application server. In other embodiments, a server 106 provides a remote authentication dial-in user service (“RADIUS”). The server 106 can be a blade server.

The processor 110 of the server 106 can be any logic circuitry that responds to and processes instructions fetched from a main memory unit. In many embodiments, the processor 110 can be provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif.

In various embodiments, the processor 110 includes multiple processors and provides functionality for simultaneous execution of instructions or for simultaneous execution of one instruction on more than one piece of data. The processor 110 can include a parallel processor with one or more cores. The server 106 can be a shared memory parallel device, with multiple processors and/or multiple processor cores, accessing all available memory as a single global address space. The server 106 can be a distributed memory parallel device with multiple processors each accessing local memory only. The server 106 can have some shared memory and some memory accessibly only by particular processors or subsets thereof. In various embodiments, the server 106 can include a single package that combines two or more independent processors into a single package, such as a single integrated circuit (IC).

In some embodiments, the processor 110 executes a single instruction simultaneously on multiple pieces of data (SIMD). In other embodiments, the processor 110 executes multiple instructions simultaneously on multiple pieces of data (MIMD). However, the processor 110 can use any combination of SIMD and MIMD cores in a single device. The server 106 can be based on any of these processors, or any other processor capable of operating as described herein.

The processor 110 on the server 106 runs one or more applications, such as an application providing a thin-client computing or remote display presentation application. The server 106 can execute any portion of the CITRIX ACCESS SUITE by Citrix Systems, Inc., such as the METAFRAME or CITRIX PRESENTATION SERVER and/or any of the MICROSOFT WINDOWS Terminal Services manufactured by the Microsoft Corporation. The server 106 can execute an ICA client, developed by Citrix Systems, Inc. of Fort Lauderdale, Fla. The server 106 can run email services such as MICROSOFT EXCHANGE provided by the Microsoft Corporation of Redmond, Wash. The applications can include any type of hosted service or products, such as GOTOMEETING provided by Citrix Online Division, Inc. of Santa Barbara, Calif., WEBEX provided by WebEx, Inc. of Santa Clara, Calif., or Microsoft Office LIVE MEETING provided by Microsoft Corporation of Redmond, Wash.

The processor 110 on server 106 can also execute an application on behalf of a user of a mobile computing device 102. In some embodiments, the server 106 executes a virtual machine that provides an execution session. The server 106 executes applications on behalf of the user within the execution session. In various embodiments, the execution session provides access to a computing environment that includes one or more of: an application, a plurality of applications, a desktop application, and a desktop session. In some embodiments, the desktop session is a hosted desktop session.

With continuing reference to FIG. 1, the mobile computing device 102 and its components for use in the system 100 will now be described. In various embodiments, the mobile computing device 102 may be a JAVA-enabled cellular telephone or personal digital assistant (PDA), such as, for example, the i55sr, i58sr, i85s, i88s, i90c, i95cl, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the mobile computing device 102 is a mobile device manufactured by Nokia of Finland, or by Sony Ericsson Mobile Communications AB of Lund, Sweden. In still other embodiments, the mobile computing device 102 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the mobile computing device 102 is a smart phone, Pocket PC, Pocket PC Phone, or other handheld mobile device supporting Microsoft Windows Mobile Software. In another of these embodiments, the mobile computing device 102 is an iPhone smartphone, manufactured by Apple Computer of Cupertino, Calif.

The processor 125 of the mobile computing device 102 can be any processor described herein with reference to the processor 110 of the server 106.

The virtual graphics driver 135 can be a driver-level component that manages the extended virtual screen 130, which may be a frame buffer. The virtual graphics driver 135 of the mobile computing device 102 can store output received from the server 106 on the extended virtual screen 130. In many embodiments, the virtual graphics driver 135 transmits data on the extended virtual screen 130 to the native display 140 for display.

The native display 140 can display output on the extended virtual screen 130. The native display 140 can also receive user input. In some embodiments, the native display 140 receives a gesture-based instruction through a touch-screen. The touch-screen can include a touch-responsive surface that detects touch input from a user of the mobile computing device 102. The touch-responsive surface identifies the locations where the user touches the surface and redirects the locations to the mobile computing device's processor 125. The processor 125 interprets the locations of the user input to determine a user instruction. In various embodiments, the user instruction can be a zoom, scroll, or pan instruction, or any other instruction as would be evident to one of ordinary skill in the art.

With continuing reference to FIG. 1, the network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a first network is a private network and a second network is a public network. Alternatively, both the first and second networks are private networks, or public networks.

The network 104 can be any type and/or form of network, including any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 includes a wireless link, such as an infrared channel or satellite band. The topology of the network 104 can be a bus, star, or ring network topology. The network 104 can be of any such network topology as known to those ordinarily skilled in the art capable of supporting the operations described herein. The network can include mobile telephone networks utilizing any protocol or protocols used to communicate among mobile devices, including AMPS, TDMA, CDMA, GSM, GPRS or UMTS. In some embodiments, different types of data can be transmitted via different protocols. In other embodiments, the same types of data can be transmitted via different protocols.

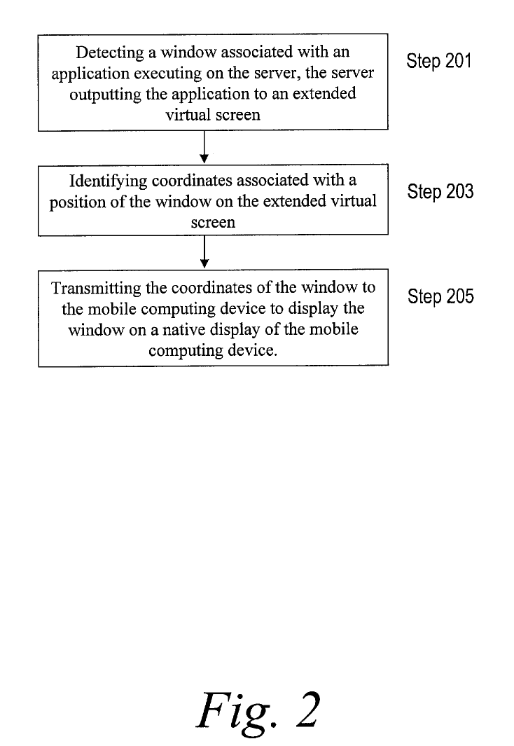

FIG. 2 is a flow diagram depicting one embodiment of the steps taken in a method for displaying, on a mobile computing device, a window of an application executing on a server. In this embodiments, the method includes: detecting a window associated with an application executing on a server, the server outputting the application to an extended virtual screen (step 201); identifying coordinates associated with a position of the window on the extended virtual screen (step 203); and transmitting the coordinates of the window to a mobile computing device to display the window on a native display of the mobile computing device (step 205).

Referring still to FIG. 2, and in greater detail, server 106 detects a window associated with an application (step 201). In some embodiments, processor 110 on the server 106 detects the window by scraping the extended virtual screen 115 that receives output of the executed application. For example, the processor 110 may perform optical character recognition (OCR) algorithms on the data in the application to detect windows and gather information about them. In another example, the processor 110 may query the underlying programming objects associated with output to the extended virtual screen 115 to gather information.

The processor 110 may gather any type and form of information about a window on the extended virtual screen 115. In some examples, the processor 110 may gather the name of the window, the position of the window on the extended virtual screen, the size of the window, the application associated with the window, or any combination thereof. The processor 110 may identify the type of window. For example, the processor 110 may determine if the window is a dialogue box, a user interface, a notification, or a warning. The processor 110 may determine whether the window requires user focus, such that the mobile computing device 102 may pan the native display 140 to the window to bring the window to the user's attention. The processor 110 may gather information about the contents of the window, such as whether the window includes a scrollbar.

As the processor 110 detects each window, the processor 110 may add information about the window to an array of information about a plurality of windows outputted to the extended virtual screen 115. The array may include any combination of the information gathered about each window. For example, an entry in the array may indicate that window #1 is a “File Open” window, associated with Microsoft Word, positioned at coordinates (480, 680) on the extended virtual screen, a child dialogue box, and requires user focus. In another example, an entry may indicate that window #2 is a “New E-mail” window, associated with Microsoft Outlook, positioned at coordinates (560, 240) on the extended virtual screen, a notification, and does not require user focus. In yet another example, an entry may indicate that window #7 is a “Pop-up Advertisement” window, associated with a web browser, positioned at coordinates (300, 270) on the extended virtual screen, a notification, and does not require user focus.

In some embodiments, the processor 110 may discover an entry in the array already corresponding to a window detected during a screen scrape. If any of the gathered information about the window has changed, the processor 110 may update the entry. In various embodiments, the processor 110 may discover that a window corresponding to an entry in the array is no longer displayed on the extended virtual screen 115. For example, a dialogue box may have closed upon receipt of a user input, or a temporary window announcing receipt of a new e-mail may have closed after a pre-determined elapse of time. The processor may remove 110 the entry corresponding to the closed window from the array.

The processor 110 may scrape the extended virtual screen 115 at any time or in response to any event, as would be apparent to one of ordinary skill in the art. The processor 110 may scrape the extended virtual screen 115 for windows after pre-determined intervals of time. Application-specific events may also initiate screen scrapes. For example, user actions known to generate child dialogue boxes for receiving further user input may trigger such a scrape. Thus, commands to open a file, access a help menu, adjust a parameter used by the application (e.g., font size, page margins, volume of sound), or other actions as would be evident to one of ordinary skill would signal the processor to scrape the extended virtual screen 115.

In addition to, or in lieu of, scraping the extended virtual screen 115, the processor 110 may detect a window by identifying a window upon an event trigger. The event trigger may be coded into an application executing on a server 106. In some embodiments, applications may include event triggers inserted by the application developers. For example, an event trigger for an application may fire whenever the server 106 receives a notification from a third-party server associated with the application indicating that application updates are available. In another example, an event trigger for an application may halt execution of an application after a pre-determined trial period for the user has elapsed. In a third example, an event trigger for an application may recover files upon detecting that the application previously closed without proper shutdown.

In more embodiments, users may code event triggers into applications available on the server. In these embodiments, the server 106 may open the application source code to the user, thereby allowing the user to customize the application. A user may insert code that executes upon a specified event, and the code may indicate where the native display 140 pans when the event occurs. For example, a user-inserted event trigger may detect a keystroke or combination therefore, such as “Ctrl-X.” In response, the event trigger may pan the native display 140 to a pre-determined portion of the extended virtual screen 130, such as the upperleft-hand corner. In another example, a user-inserted event trigger may detect notifications from an application that normally do not require user focus. The event trigger may override the processor's 110 operation and pan the native display 140 to the notification.

After detecting a window associated with an application, the processor 110 may identify coordinates associated with a position of the window on the extended virtual screen 115 (step 203). When the processor 110 detects the window via screen scraping, the processor 110 may consult the array of information about the plurality of windows outputted to the extended virtual screen 115 to identify the coordinates of the window. The processor 110 may retrieve the coordinates from the entry corresponding to the window.

When the processor 110 detects the window through an event trigger, the processor 110 may obtain the coordinates referenced by the event trigger. In some embodiments, the event trigger may specify the coordinates of the window. For example, if the keystroke “Ctrl-X” pans the native display to the upperleft-hand corner of the extended virtual screen 115, the event trigger may include an instruction to pan to a window whose upper-lefthand corner is located at (0, 768) on a 1024 pixel×768 pixel screen. In other embodiments, the event trigger indicates how to obtain the coordinates of the window. For example, if an e-mail notification opens a temporary window, the event trigger may instruct the native display 140 to pan to a location according to the entry of the array corresponding to the temporary window.

After the server 106 identifies coordinates associated with a position of the window on the extended virtual screen 115, the transceiver 120 on the server 106 may transmit the coordinates of the window to the mobile computing device 102 to display the window on a native display 140 of the mobile computing device 102 (step 205). The transceiver 145 may receive the coordinates and forward the coordinates to the processor 125 of the mobile computing device 102. The processor 125 may communicate with the virtual graphics driver 135 to drive the native display 140 according to the received coordinates. In some embodiments, the coordinates correspond to an upperleft-hand corner of the window. In other embodiments, the coordinates correspond to the center of the window.

In many embodiments, when the server 106 detects a window through screen scraping, the transceiver 145 may transmit the coordinates only if the window requires user focus. Such a window must or ought to be brought to the mobile computing device user's attention. For example, a child dialogue box opens to receive input from the user, and the application halts until the dialogue box receives the desired input. If the child dialogue box appears on the extended virtual screen 115 outside the native display 140, from the user's perspective, the application appears unresponsive. The child dialogue box must be brought to the user's attention to continue execution of the application. In another example, a warning may indicate that a website the user is accessing may have questionable credentials. Because the website may impact the mobile computing device's security, the warning ought to be brought to the user's attention. In another example, accessing a website may open a pop-up advertisement, which does not require user focus. In any of these embodiments, the processor 110 determines if the window requires user focus by accessing the entry in the array corresponding to the window.

In some embodiments, the server 106 may also transmit an instruction to zoom to the mobile computing device 102. The server 106 may determine if a zoom instruction is appropriate by evaluating the resolutions of the extended virtual screen 115 and native display 140 or by evaluating the sizes of the window and native display 140. For example, the processor 110 may decide that zooming is appropriate if the resolutions of the extended virtual screen 115 and native display 140 differ by at least a predetermined threshold. In another example, the processor 110 may decide that zooming is appropriate if the sizes of the window and native display 140 differ by at least another predetermined threshold. The processor 110 may compare the differences against separate thresholds to determine if the native display 140 should zoom in or zoom out. The mobile computing device 102 may perform any algorithm on data in the extended virtual screen 130 to achieve the zoom, such as interpolation or sampling.

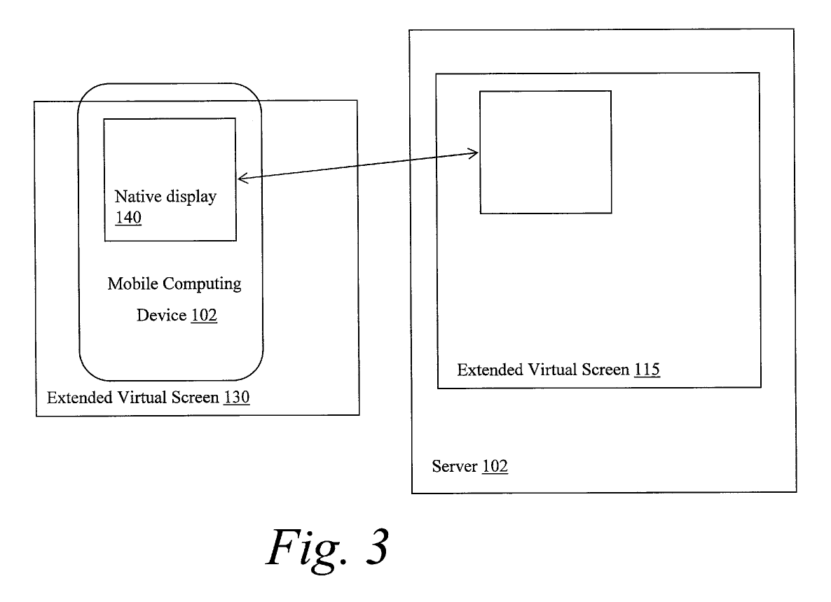

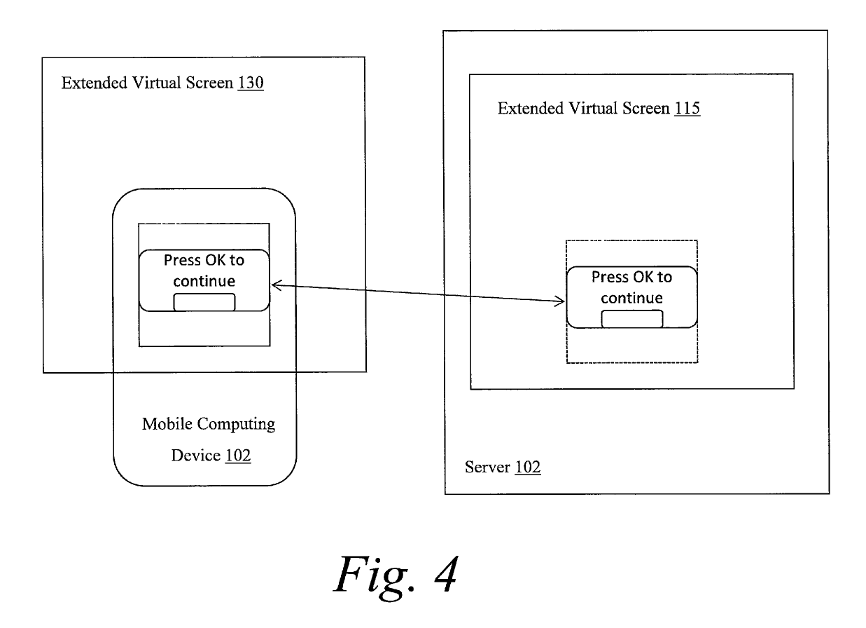

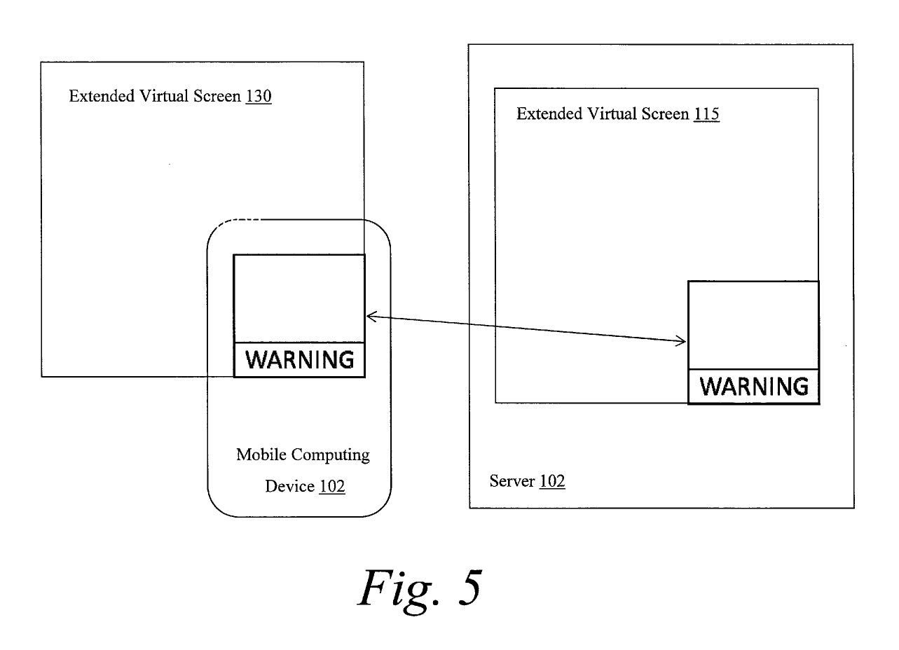

FIGS. 3, 4, and 5 are block diagrams depicting the relationship between the application output to the extended virtual screen 115 on the server 106 and the output on the native display 140, according to the present disclosure. With particular reference to FIG. 3, typically, the resolution of the extended virtual screen 115 is larger than the resolution of the native display 140. Therefore, the native display 140 displays only a portion of the extended virtual screen 115. The server 106 communicates with the mobile computing device 102 to drive the native display 140 to display a desired portion of the extended virtual screen 115. For example, in FIG. 4, and as described hereinabove, the server 106 passes coordinates for a child dialogue box to the mobile computing device 102 to display the child dialogue box on the native display 140. In FIG. 5, in another example, the server 106 passes coordinates for the warning to the mobile computing device 102 for display on the native display 140.

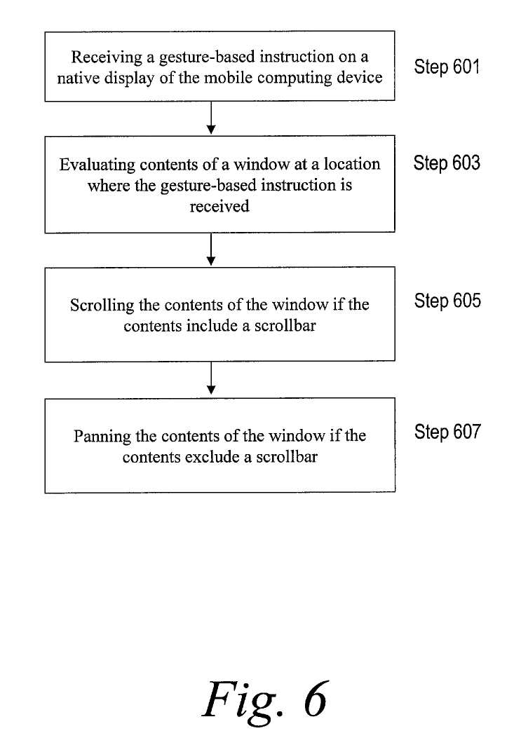

FIG. 6 is a flow diagram depicting one embodiment of the steps taken in a method for interpreting a gesture-based instruction according to contents of a window displayed on a native display of a mobile computing device. In one embodiment, the method includes: receiving a gesture-based instruction on a native display of the mobile computing device (step 601); evaluating contents of a window at a location where the gesture-based instruction is received (step 603); scrolling the contents of the window if the contents include a scrollbar (step 605); and panning the contents of the window if the contents exclude a scrollbar (step 607).

Referring still to FIG. 6, and in greater detail, the mobile computing device 102 receives a gesture-based instruction on a native display 140 of the mobile computing device 102 (step 601). The native display 140 includes a touch-responsive surface that detects touch input from a user of the mobile computing device 102. The touch-responsive surface may identify the locations where the user touches the surface and redirect the locations to the processor 125 on the mobile computing device 102. In some embodiments, the touch-responsive surface redirects only the beginning and end locations of the user touch input to the processor 125. In other embodiments, the touch-responsive surface redirects the locations received on a periodic basis.

In some embodiments, the gesture-based instruction may be an instruction to shift the data on the native display 140. For example, the user may touch the touch-responsive surface at one location and drag a finger or a stylus along a line. The processor 125 may calculate the magnitude of the instruction in any number of ways. In some embodiments, the processor 125 may calculate a distance between the beginning and end locations of the user touch input. In other embodiments, the processor 125 may calculate one distance between the beginning and end locations along one axis of the native display 140 and another distance between the locations along the other axis of the native display 140.

After receiving a gesture-based instruction on a native display of the mobile computing device, the mobile computing device 102 evaluates contents of a window at a location where the gesture-based instruction is received (step 603). The mobile computing device 102 may detect the window according to the location where the user touch input begins. In some embodiments, the processor 125 may consult the array of information about the plurality of windows on the extended virtual screen 130 to identify the window at that location. In other embodiments, user touch input at a location that includes a window may trigger an event that identifies the window.

Once the processor 125 identifies the window, the processor 110 may evaluate the contents to determine if the contents include a scrollbar. For example, the processor 110 may access the window's entry in the array of information about windows on the extended virtual screen 130. The entry may indicate whether the window includes a scrollbar, which may have been determined during a screen-scrape. In another example, the processor 125 may access the data structure, such as an object, corresponding to the window to determine if the window includes a scrollbar. In any of these examples, the processor 125 may determine the directional movement of the scrollbar, e.g. horizontal or vertical.

After evaluating contents of a window at a location where the gesture-based instruction is received, the mobile computing device 102 scrolls the contents of the window if the contents include a scrollbar (step 605) or pans the contents of the window if the contents exclude a scrollbar (step 605). If the window includes a scrollbar, the processor 125 may transmit to the server 106 an instruction to scroll contents of the window output by the application executing thereon. The instruction may include the magnitude and direction for scrolling. The processor 125 may compute the magnitude according to any algorithm as would be evident to one of ordinary skill in the art. For example, the magnitude may be proportional to the overall distance between the beginning and end locations of the user touch input, the distance along the directional movement of the scrollbar between the locations, or any other such distance. The processor 125 may compare the beginning and end locations according to the directional movement of the scrollbar to determine the direction for scrolling.

If the window excludes a scrollbar, the processor 125 may transmit to the server 106 an instruction to pan contents of the window output by the application executing thereon. In these embodiments, the instruction to pan includes two instructions to move contents, one along a vertical direction and the other along a horizontal direction. For the instruction to move in a horizontal direction, the magnitude may be proportional to the horizontal distance between the beginning and end locations of the user touch input. The processor 125 may determine the direction for horizontal movement, i.e. left or right, by comparing the locations. The magnitude and direction for an instruction to move in a vertical direction may be determined through comparable methods.

In all of these embodiments, the mobile computing device 102 receives from the server 106 updated contents of the window according to the transmitted instruction. The processor 125 communicates with the virtual graphics driver 135 to store the updated contents on the extended virtual screen 130. The virtual graphics driver 135, in turn, drives the native display 140 to display the updated contents.

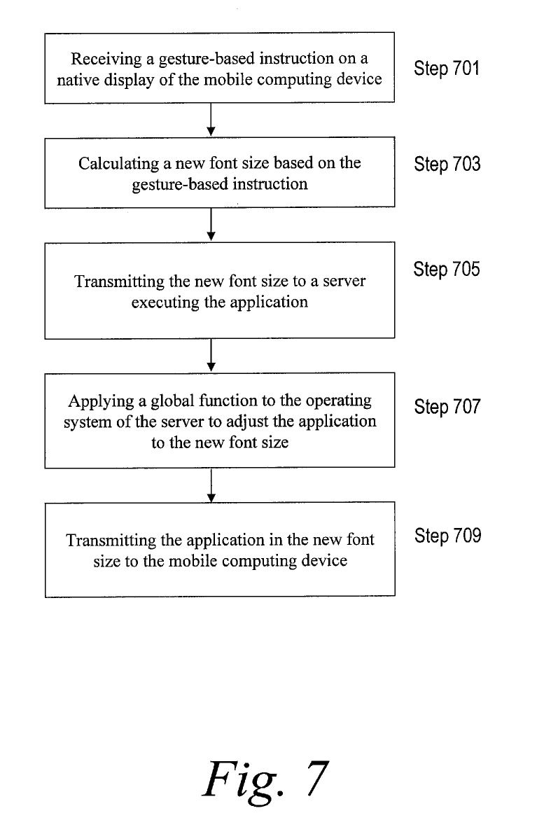

FIG. 7 is a flow diagram depicting one embodiment of the steps taken in another method for interpreting a gesture-based instruction according to contents of a window displayed on a native display of a mobile computing device. In one embodiment, the method includes: receiving a gesture-based instruction on a native display of the mobile computing device (step 701); calculating a new font size based on the gesture-based instruction (step 703); transmitting the new font size to a server executing an application (step 705); applying a global function to the operating system of the server to adjust the application to the new font size (step 707); and transmitting the application in the new font size to the mobile computing device (step 709). The mobile computing device 102 may receive the gesture-based instruction according to any of the methods described in reference to FIG. 6.

After receiving the gesture-based instruction on a native display 140 of the mobile computing device 120, the processor 125 on the mobile computing device 102 calculates a new font size based on the gesture-based instruction. When the gesture-based instruction is a zoom instruction, the user touch input includes two lines received on the touch-screen. The processor 125 then compares the beginning locations of the lines with the end locations to determine if the user seeks to zoom in or zoom out of the application. The processor 125 computes lengths of the lines to determine the magnitude of the zoom and calculates the new font size using the computed lengths.

In some embodiments, the processor 125 may multiple or divide the font size used by the application by a factor proportional to the computed lengths to calculate the new font size. In other embodiments, the processor 125 may obtain the factors via a look-up table with entries corresponding to possible computed lengths and zoom in/out. Alternatively, the processor 125 may compute the factor directly from the computed lengths.

After calculating a new font size based on the gesture-based instruction, the mobile computing device 102 transmits the new font size to a server executing an application and the server applies a global function to the operating system of the server to adjust the application to the new font size. The server 106 calls an API using the new font size. The API may override the parameters used by the operating system to display the application in the new font size. In some embodiments, the API may automatically address text-wrapping concerns. The processor outputs the application in the new font size to the extended virtual screen 115. Then, the server 106 transmits the application in the new font size to the mobile computing device 102 for display.

Having described certain embodiments of methods and systems for displaying, on a mobile computing device, a window of an application executing on a server, it will now become apparent to one of skill in the art that other embodiments incorporating the concepts of the invention may be used. Therefore, the invention should not be limited to certain embodiments.

What is claimed:

1. A method for displaying, on a mobile computing device, a window of an application executing on a server, the method comprising:
detecting, by a server, a window associated with an application executing on the server, the server outputting the application to an extended virtual screen;
identifying, by the server, coordinates associated with a position of the window on the extended virtual screen;
transmitting, by the server, the coordinates of the window to the mobile computing device to display the window on a native display of the mobile computing device.

2. The method of claim 1, wherein the window is one of a dialogue box, a user interface, a notification, and a warning.

3. The method of claim 1, further comprising:
comparing, by the server, a resolution of the extended virtual screen on the server with a resolution of the native display on the mobile computing device;
determining, by the server, if the resolutions differ by a predetermined threshold; and
transmitting, by the server, an instruction for zooming on the window if the resolutions differ by at least the predetermined threshold.

4. The method of claim 1, wherein the coordinates of the window are obtained by scraping the extended virtual screen.

5. The method of claim 1, wherein the server detects the window in response to an event trigger, the event trigger is selected from a group consisting of an event trigger coded by an application developer and an event trigger inserted by an application user.

6. The method of claim 5, wherein a user of the mobile computing device specifies the event trigger by customizing the application executing on the server.

7. The method of claim 1, further comprising
receiving, by the mobile computing device, a gesture-based instruction on the native display;
evaluating, by the mobile computing device, contents of a window at a location where the gesture-based instruction is received;
scrolling, by the mobile computing device, the contents of the window if the contents include a scrollbar; and
panning, by the mobile computing device, the contents of the window if the contents exclude a scrollbar.

8. A computer-implemented system for displaying a window of an application executing on a server on a native display of a mobile computing device, the system comprising:
a server including
a processor that detects a window associated with an application and identifies coordinates associated with a position of the window on an extended virtual screen; and
a transceiver that transmits the coordinates of the window to a mobile computing device; and
a mobile computing device including
a native display that displays the window according to the coordinates from the server.

9. The system of claim 8, wherein the window is one of a dialogue box, a user interface, a notification, and a warning.

10. The system of claim 8, wherein the processor compares a resolution of the extended virtual screen on the server with a resolution of the native display on the mobile computing device, determines if the resolutions differ by a predetermined threshold, and transmits an instruction for zooming on the window if the resolutions differ by at least the predetermined threshold.

11. The system of claim 8, wherein the processor scrapes the extended virtual screen to identify the coordinates of the window.

12. The system of claim 8, wherein the processor detects the window in response to an event trigger, the event trigger being selected from a group consisting of an event trigger coded by an application developer and an event trigger inserted by an application user.

13. The system of claim 12, wherein a user of the mobile computing device specifies the event trigger by customizing the application executing on the server.

14. The system of claim 8, wherein
the native display on the mobile computing device receives a gesture-based instruction; and
the processor on the mobile computing device evaluates contents of a window at a location where the gesture-based instruction is received, scrolls the contents of the window if the contents include a scrollbar, and pans the contents of the window when the contents exclude a scrollbar.

15. A method of interpreting a gesture-based instruction according to contents of a window displayed on a native display of a mobile computing device, the method comprising:
receiving, by a mobile computing device, a gesture-based instruction on a native display of the mobile computing device;
evaluating, by the mobile computing device, contents of a window at a location where the gesture-based instruction is received;
scrolling, by the mobile computing device, the contents of the window if the contents include a scrollbar; and
panning, by the mobile computing device, the contents of the window if the contents exclude a scrollbar.

16. The method of claim 15, wherein scrolling the contents of the window comprises transmitting, by the mobile computing device, an instruction to scroll contents of the window output by an application executing on a server.

17. The method of claim 16, wherein scrolling the contents of the window comprises
receiving, by the mobile computing device, updated contents of the window from the server according to the transmitted instruction, and
displaying, by the mobile computing device, the updated contents on the native display.

18. The method of claim 15, wherein evaluating contents of a window comprises scraping the window to determine if the window includes a scrollbar.

19. The method of claim 15, further comprising
calculating, by the mobile computing device, a new font size based on the gesture-based instruction;
transmitting, by the mobile computing device, the new font size to a server executing the application;
applying, by the server, a global function to the operating system of the server to adjust the application to the new font size; and
transmitting, by the server, the application in the new font size to the mobile computing device.

20. A mobile computing device for interpreting a gesture-based instruction according to contents of a window displayed on a native display of a mobile computing device, the mobile computing device comprising:
a native display that receives a gesture-based instruction;
a processor that
evaluates contents of a window at a location where the gesture-based instruction is received;
scrolls the contents of the window if the contents include a scrollbar; and
pans the contents of the window if the contents exclude a scrollbar.

21. The device of claim 20, wherein a processor scrolls the contents of the window by transmitting an instruction to scroll contents of the window output by an application executing on a server.

22. The device of claim 21, wherein the processor scrolls the contents of the window by receiving, from a server, updated contents of the window according to the transmitted instruction.

23. The device of claim 20, wherein the processor evaluates contents of the window by scraping the window to determine if the window includes a scrollbar.

24. The device of claim 20, wherein the processor calculates a new font size based on the gesture-based instruction and transmits the new font size to a server executing the application, and the server applies a global function to the operating system of the server to adjust the application to the new font size and transmits the application in the new font size to the mobile computing device.

25. A method for rendering a window from an extended virtual screen on a native display of a mobile computing device, the method comprising:
detecting, by a server, a first window associated with an application executing on the server, the server outputting the application to an extended virtual screen;
identifying, by the server, coordinates associated with a position of the first window on the extended virtual screen;
transmitting, by the server, the coordinates of the first window to a mobile computing device to display the first window on a native display of the mobile computing device;
receiving, by the mobile computing device, a gesture-based instruction on the native display;
evaluating, by the mobile computing device, contents of a second window at a location where the gesture-based instruction is received;
scrolling, by the mobile computing device, the contents of the second window if the contents include a scrollbar; and
panning, by the mobile computing device, the contents of the second window if the contents exclude a scrollbar.
